(19) United States
(12) Patent Application Publication
(10) Pub. No.: US 2009/0115857 A1
(43) Pub. Date: May 7, 2009

(54) Image capturing apparatus providing image blur information and method thereof

(76) Inventors: Yun-Chin Li, Banciao (TW); Chin-Lung Yang, Toufen Township (TW); Shih-Chang Han, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,559

(22) Filed: Jul. 24, 2008

(30) Foreign Application Priority Data
Nov. 2, 2007 (TW) 96141511

(51) Int. Cl. H04N 5/228

(52) U.S. Cl. 348/208.1; 348/E05.031

(57) ABSTRACT

A method for providing image blur information is applied to a photographing mode of image capturing apparatus of which a shooting shutter speed is greater than a safe shutter speed, the method comprising the steps of: capturing a long exposure image in the shooting shutter speed and a short exposure image which is smaller than or equal to the safe shutter speed, in order to search correspondingly a plurality of characteristic positions in the long exposure image and the short exposure image, and then comparing the characteristics on the relative characteristic positions between the long exposure image and the short exposure image to produce a comparing result upon which a further operation is performed to define a degree of image blur. Thus, the present invention can achieve the purpose of providing image blur information for the long exposure image when the image capturing apparatus captures the long exposure image.

### BACKGROUND OF THE INVENTION

1. Field of the Invention

This invention relates to an image capturing device and particularly to an image capturing apparatus providing image blur information.

2. Description of Related Art

In recent years, thanks to the fast development of a digital image and optics technology, a digital still camera (DSC) is quite popular and well rounded. In daily life, a user uses a shot photograph at a high pitch as a means and manner of recording information required.

Currently, although a DSC vibration reduction technology is gradually progressive, an environment where the user shoots a photo each time, and a condition of ambient light offset are not constant, and further the effects of image blur control supported by the DSC are different at different shooting modes; especially when the user takes a picture at a long exposure mode (low speed shutter), the image becomes very blurry.

The DSC matches with a memory card (or a built-in memory) in a technology of digital image access, so the amount of shot photos is not limited to the cost and it is easy for the user to delete the photos or repeat to shoot a photo. In this case, after using the DSC to shoot the photo, the user switch the shooting mode to the playback mode to verify whether the shot photograph is blurry, determining to keep it or delete it and repeat to shoot a photo.

However, this manner is limited to a display of the DSC, and the display size or the surrounding rays of light affecting the display generally make the user not clearly and accurately determine whether the photo is clear or blurry on the scene. Improvement is made for the user directly to determine whether the shot photograph is blurry without transferring the shot photograph to a computer, which prevents the user from missing general appearance of a picture on the scene. What is described above is just improved in DSC design and development.

Consequently, because of the technical defects of described above, the applicant keeps on carving unflaggingly through wholehearted experience and research to develop the present invention, which can effectively improve the defects described above.

### SUMMARY OF THE INVENTION

Accordingly, the technical issues mentioned above are solved in this invention by means of multiple exposure at a long exposure mode as a shooting mode. Two images that are continuously shot at a scene are a long exposed image and a short exposed image, and further the clear short exposed image is used to determine whether the long exposed image is blurry. Thus, the DSC is used to operate for the condition of image blur and tell the user the precise information about the degree of image blur of a shot photograph long exposed, which allows the user to determine to keep or delete the photograph or re-shoot a photo.

In order to achieve the object, in an approach provided in this invention, an image capturing apparatus providing image blur information is provided and provides the image blur information at a shooting mode where a shooting shutter is larger than a safety shutter, the image capturing apparatus comprising an image capturing unit, a processing unit, and a display. The image capturing unit receives a shooting signal to capture a first image at the shooting shutter and a second image smaller than the safety shutter. The processing unit generates the shooting signal and receive the first image and the second image to search for a plurality of relative characteristic positions in the first image and the second image and then compare the characteristics on the characteristic positions relative to the first image and the second image to generate a compared result, a further operation is did to define a degree of image blur according to the result. The display is connected to the processing unit to display the first image and extra information about the degree of image blur.

In order to achieve the object, in another approach provided in this invention, a method for providing image blur information is applied to the image capturing apparatus in a photographing mode of which the shooting shutter is greater than the safe shutter, the method comprising the steps of: capturing a first image in the shooting shutter and a second image which is smaller than or equal to the safe shutter, to search correspondingly a plurality of characteristic positions in the first image and the second image, and then comparing the characteristics on the relative characteristic positions between the first image and the second image to produce a comparing result upon which a further operation is did to define a degree of image blur. Thus, the image capturing apparatus may provide the image blur information about the first image.

In order to further elaborate the technical means and effects adopted for the object of this invention, refer to the detailed description according to this invention accompanied with drawings; it is believed that the object, features, and points of this invention will be apparent from the description; however, the accompanied drawings are provided for reference and illustration only and not limited to this invention.

### BRIEF DESCRIPTION OF THE DRAWINGS

FIG. 1 is a block diagram of an image capturing apparatus providing image blur information in an embodiment of this invention;

FIG. 2 is a flow chart of the image capturing apparatus providing image blur information in a first embodiment of this invention;

FIG. 3 is a flow chart of the image capturing apparatus providing image blur information in a second embodiment of this invention;

FIG. 4 is a schematic view illustrating the image capturing apparatus displaying image blur information in an embodiment of this invention; and

FIG. 5 is a schematic view illustrating the image capturing apparatus playing back characteristic blur degree information in an embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

In this invention, in a shooting mode of long exposure, by means of multiple exposure, two images are continuously shot at a scene (into a long exposed image and a short exposed image), and further the clear short exposed image is used to determine whether the long exposed image is blurry, thereby image blur information being provided.

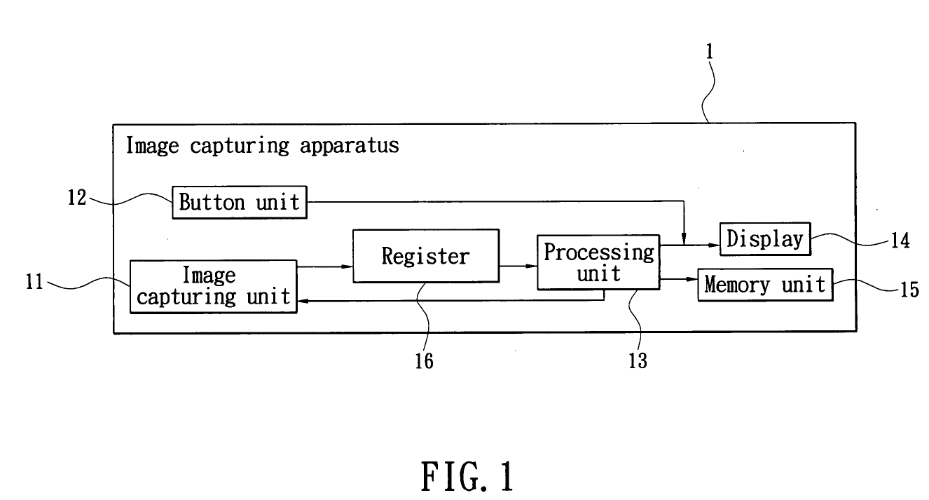

Refer to FIG. 1 as a block diagram of an image capturing apparatus providing image blur information in an embodiment of this invention. As shown in the figure, the image capturing apparatus 1 providing image blur information according to this invention comprises an image capturing unit 11, a button unit 12, a processing unit 13, a display 14, a memory unit 15, and a register 16. The image capturing apparatus 1 according to this invention mainly makes it a condition that when a user set up the image capturing apparatus 1 for a shooting mode of which a shooting shutter speed larger than a safe shutter speed, the image capturing apparatus 1, when shooting an image each time, will automatically provide image blur information about the shot image for the user to determine to keep the shot image or delete it and re-shoot an image.

The so-called safe shutter speed is designed following various sets of image capturing apparatus 1, for example, generally a shutter per 1/60 or 1/30 second. Namely, when using the shooting shutter speed larger than the safe shutter speed to shoot, the user more easily shoots a blurry image due to long exposure and thus vibration or a poor environment. Thus, from the given image blur information, the user may see the operated image consider to re-shoot or not.

Further, in the embodiment, before using the image capturing apparatus 1 to shoot, the user sets up a scale of shooting shutter (larger than that of safe shutter) and presses the button unit 12 to issue a triggering signal to the processing unit 13 to shoot. After receiving the triggering signal, the processing unit 13 issues a shooting signal to the image capturing unit 11. Accordingly, after receiving the shooting signal, the image capturing unit 11 automatically at a time and scene capture a first image in the current shooting shutter speed and a second image in a shutter smaller speed than or equal to the safe shutter speed. Namely, the first image captured by the image capturing unit 11 easily becomes a defocused and blurry image because the shooting shutter speed is larger than the safe shutter speed and longer than the exposure time; the second image is shortly exposed and relatively becomes a sharp and clear image because the shutter speed is smaller than or equal to the safe shutter speed. Thus, the second image may be used for comparison and reference to distinguish the degree of image blur of first image. The scale of shutter speed smaller than or equal to the safe shutter speed is set by default in the image capturing apparatus 1, and the shutter speed is designed mainly following the safe shutter speed of various sets of image capturing apparatus 1, in which the scale is not limited in the embodiment.

The register 16 is connected between the image capturing unit 11 and the processing unit 13 to temporarily store the first image and the second image captured by the image capturing unit 11 and then provide them for the processing unit 13. After receiving the first image and the second image, the processing unit 13 relatively searches for a plurality of characteristic positions in the first image and the second image. The characteristic position may be, for example, an Edge, a Corner, or a Line as sample for characteristic comparison, and each of various characteristic positions practically designed may be compared with different characteristics and may also be compared with the same characteristics. Besides, each of the characteristics is provided with weights for the processing unit 13 to operate, in which the weights may be set in proportion to the same weights according to a practical use or to dissimilar weights according to the difference of characteristic positions of the images.

Next, the processing unit 13 compares the characteristic positions relatively found in the first image and the second image to generate a comparison result. The first image and the second image belongs to the images continuously shot at the scene, so relative searching for multiple characteristic positions of the first and second images means that multiple characteristic positions are relatively searched at the same scene separately between the two images for implementation of characteristic comparison. For example, the characteristics are searched in the clear second image, in which the characteristic positions are coordinates A and coordinates B; further, the characteristics may also be compared at a region adjacent to the characteristic positions over coordinates A and B in the blurry first image; thus, with the partial difference made from the characteristic comparison of the relative characteristic positions in the first and second images, a comparison result is generated. If the characteristic is the edge or the simple line, the characteristic for a partial profile or frequency response of the relative characteristic position in the long exposed image (the first image) may be analyzed, and then the characteristic is solved for the similarity of two different images, in which high similarity represents that the long exposed image approach the definition of shortly exposed image (second image).

Then, the processing unit 13 uses the comparison result to operate for definition of the degree of image blur. The display 14 is connected to the processing unit 13 to display the first image shot by the user in the current shooting shutter and further the extra information about the degree of image blur of the first image. The display 14, for example, displays the information about the degree of image blur in the form of a pie chart or bar chart in percentage. Hence, the information about the degree of image blur of first image shot in the current shooting shutter is provided for the user to determine to re-shoot or reserve the image.

It is nevertheless especially noted that the processing unit 13 compares to yield the result, and thus the degree of image blur is defined; actually, two manners may be implemented for the design.

In one of the manners, the relative characteristic positions of the first and second images are simply compared, and the second image is used as reference for comparison so that each of the characteristic coincidence values (comparison result) is generated at each of the characteristic positions of the first image. Briefly speaking, dichotomization is used to determine whether the relative characteristic positions of the first and second images accord with each other to generate the characteristic coincidence values. Thus, the processing unit 13 multiplies each of the characteristic coincidence values at each of the characteristic positions by each of the weights of the characteristic positions and then sum up the values to define the degree of image blur. For example, if the relative characteristic positions accord with each other, 0 is representative, and if not, 1 is representative; the weights of characteristic positions are the same in design, so after the operation of multiplying and addition, it is apparent that the larger the resulted value is, the higher the degree of image blur is.

In the other manner, the relative characteristic positions of the first and second images are compared with each other at the aspect of characteristic ration or similarity, and the second image is used as reference for comparison so that a characteristic blur degree (comparison result) is generated at the characteristic position of first image. For example, if the line characteristics are used for comparison, determination is made whether the line characteristics at the same characteristic position of the first and second images are compared with each other at the aspect of thickness scale or at the aspect of similarity of the partial frequency response. Thus, the processing unit 13 likewise multiplies the characteristic blur degree of the characteristic positions by each of the weights of the characteristic positions and then sums up the values to define the degree of image blur.

Indeed, in the design of characteristic position weight, if the position is closer to the image center, the weight may be higher, and if the position is closer to the image edge, the weight may be lower; similarly, a point focused by the user may also be further designed for a higher weight.

Finally, the memory unit 15 provided in the embodiment is connected to the processing unit 13 to store the first image and meanwhile record the comparison result generated at the characteristic position searched by the processing unit 13, and the coordinates at the characteristic position searched by the processing unit 13 for the first image. Then, when the user sets the image capturing apparatus 1 at the playback mode to view the first image on the display 14, the processing unit 13 makes a plurality of marks corresponding to the first image according to the comparison result and coordinates of characteristic position that are recorded by the memory unit 15, which allows the user to get the message of the comparison result at each of the characteristic positions when viewing the first image. The marks may be further designed into different marks (such as the difference of a symbol color from a symbol type) for different comparison results, being apparent that which characteristic positions are the parts of blur.

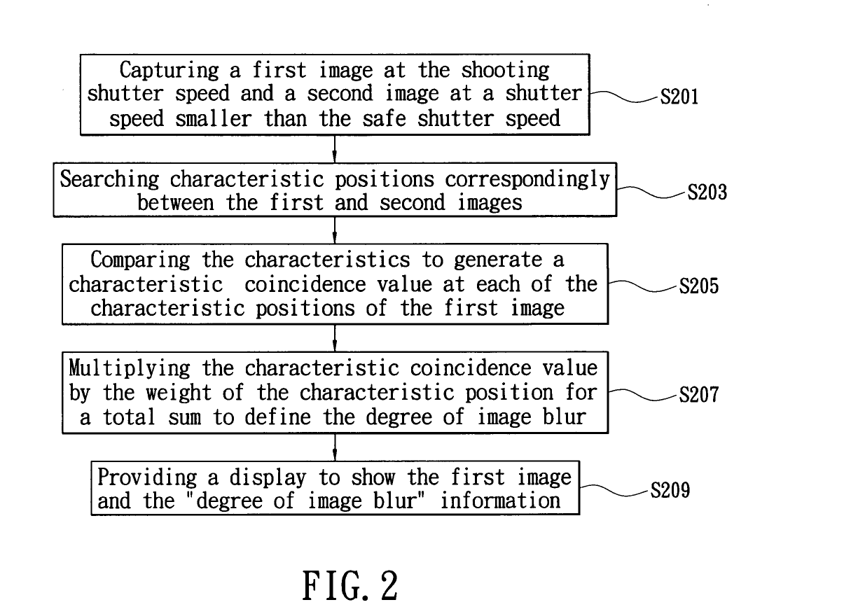

Refer to FIG. 2 as a flow chart of the image capturing apparatus providing image blur information in a first embodiment of this invention. In the method of providing the image blur information in the embodiment, the image capturing apparatus operates at the shooting mode of which the shooting shutter speed is larger than the safe shutter speed to provide the image blur information. The methods in the embodiment comprises steps described below; firstly, at a scene, the first image in the shooting shutter speed and the second image in a shutter speed smaller than or equal to the safe shutter speed are automatically captured (S201). Then, multiple characteristic positions are searched correspondingly in the first and second images (S203). Further, the relative characteristic positions of the first and second images are compared with each other, and the second image is used as reference for comparison to generate the characteristic coincidence value at each of the characteristic positions of the first image (S205) as the comparison result for the characteristic comparison. Thus, a step of operation goes, in which the characteristic coincidence value at each of the characteristic positions is multiplied by the weight of each of the characteristic positions for a total sum to define the degree of image blur of the first image (S207). Finally, the display is provided in the image capturing apparatus to display the first image and receive the degree of image blur and further the extra information about the degree of image blur of the first image (S209). Thus, the image capturing apparatus may provide the image blur information about the first image shot in the current shooting shutter.

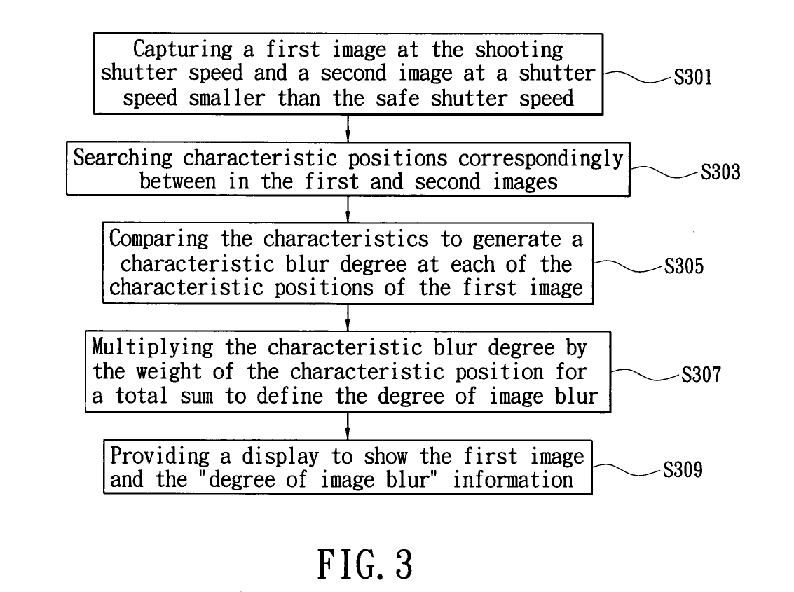

Refer to FIG. 3 as a flow chart of the image capturing apparatus providing image blur information in a second embodiment of this invention. In the method of providing the image blur information in the embodiment, the image capturing apparatus likewise operates at the shooting mode of which the shooting shutter speed is larger than the safe shutter speed to provide the image blur information. The methods in the embodiment comprises steps described below; firstly, at a scene, the first image in the shooting shutter speed and the second image in a shutter speed smaller than or equal to the safe shutter speed are automatically captured (S301). Then, multiple characteristic positions are searched correspondingly in the first and second images (S303). Further, the relative characteristic positions of the first and second images are compared with each other, and the second image is used as reference for comparison to generate the characteristic blur degree at each of the characteristic positions of the first image (S305) as the comparison result for the characteristic comparison. Thus, a step of operation goes, in which the characteristic blur degree of each of the characteristic positions is multiplied by the weight of each of the characteristic positions for a total sum to define the degree of image blur of the first image (S307). Finally, the display is provided in the image capturing apparatus to display the first image and receive the degree of image blur and further the extra information about the degree of image blur of the first image (S309). The steps in the embodiment and those in the first embodiment shown in FIG. 2 are different mainly in that the steps of characteristic comparison and operation in the two embodiments are separately implemented in different manners for comparison and operation of the characteristic positions.

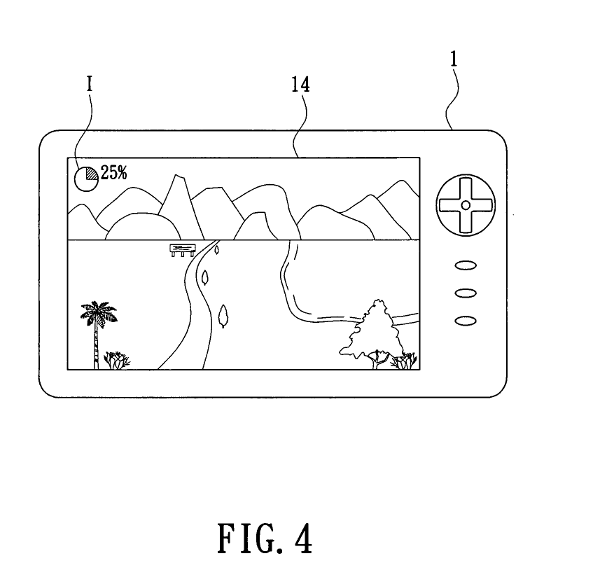

The displayed information about the degree of image blur in this invention is further described below. Refer to FIG. 4 as a schematic view illustrating the image capturing apparatus displaying image blur information in an embodiment of this invention. Suppose the user adjusts the shooting mode of the image capturing apparatus 1 to a mode of which the shooting shutter speed is larger than the safe shutter speed and shoots, the image capturing apparatus 1 automatically captures the first image in the current shooting shutter speed and the second image in the shutter speed smaller than or equal to the safe shutter speed to further show the first image on the display 14. In the image capturing apparatus 1 provided in this invention, when showing the first image, the display 14 further shows the extra degree of image blur information I through the operation described in this invention. The degree of image blur information I in the embodiment is given in the form of pie chart, and the operated first degree of image blur, for example, lies in 25%.

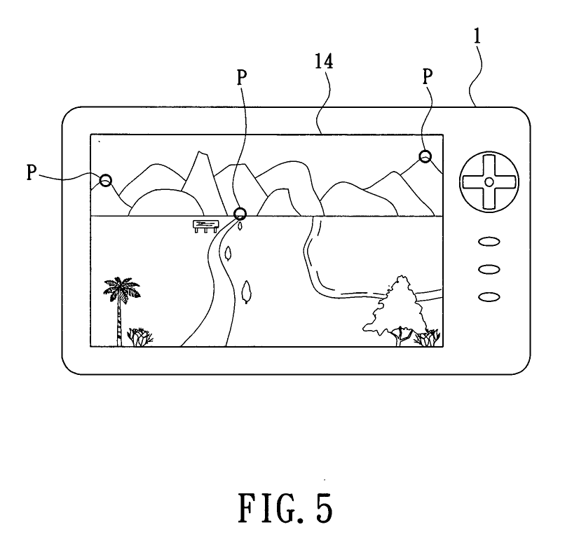

Refer to FIG. 5 as a schematic view illustrating the image capturing apparatus playing back characteristic blur degree information in an embodiment of this invention. In the embodiment, the user finishes in shooting the first image and switches the current mode where the image capturing apparatus 1 stays to the playback mode to view the first image. In this invention, when the first image is stored, the comparison result and its coordinates corresponding to the first image that are given at the found characteristic position are recorded. Thus, when the first image is viewed in the playback mode, the mark symbol P is correspondingly labeled on the first image according to the recorded comparison result and coordinates to the characteristic position, allowing the user to know why the 25% degree of image blur is caused on the first image. In the embodiment, the mark symbol P in the form of a circle is labeled on the first image.

To sum up, in the image capturing apparatus providing image blur information and method thereof according to this invention, in a shooting mode of long exposure, by means of multiple exposure, two images are continuously shot at a scene (into a long exposed image and a short exposed image), and further the clear short exposed image is used to determine whether the long exposed image is blurry. Thus, through the automatic operation of image capturing apparatus, the user get the knowledge of the degree of image blur of the long exposed image shot. The user then determines to keep or delete the image according to the accepted degree of image blur.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image capturing apparatus providing image blur information at a shooting mode of which a shooting shutter speed is greater than a safe shutter speed, comprising:
an image capturing unit, for receiving a shooting signal to capture a first image at the shooting shutter speed and a second image at a shutter speed less than the safety shutter speed;
a processing unit, for generating the shooting signal, and receiving the first image and the second image, then search for a plurality of relative characteristic positions between the first image and the second image, in order to use the second image as relative reference to the first image's characteristic positions so a compared result can be generated, furthermore an operation is done to define degree of image blur according to the comparison result; and
a display connected to the processing unit to display the first image and information about the degree of image blur.

2. The image capturing apparatus providing image blur information according to claim 1, wherein the characteristic position used for characteristic comparison may be an Edge, a Corner, or a Line.

3. The image capturing apparatus providing image blur information according to claim 1, wherein each of the characteristic positions is provided with a weight (importance value), and the weights of each kinds of the characteristic positions are to be set in proportion to the same weights or to dissimilar weights according to the coordinate difference of characteristic positions.

4. The image capturing apparatus providing image blur information according to claim 3, wherein after executing the comparison, the processing unit generates a characteristic coincidence value at each of the characteristic positions of the first image and multiplies the characteristic coincidence value by the weight of each of the characteristic weights for a total sum to define the degree of image blur.

5. The image capturing apparatus providing image blur information according to claim 3, wherein after executing the comparison, the processing unit generates a characteristic blur degree at each of the characteristic positions of the first image and multiplies the characteristic blur degree by the weight of each of the characteristic weights for a total sum to define the degree of image blur.

6. The image capturing apparatus providing image blur information according to claim 1, wherein the apparatus further comprises a memory unit connected to the processing unit to store the first image and record the first image's comparison result and the first image's coordinates of the characteristic positions.

7. The image capturing apparatus providing image blur information according to claim 6, wherein when the image capturing apparatus stays at the playback mode to show the first image on the display, the processing unit makes a plurality of marks corresponding to the first image according to the comparison result and coordinates to the characteristic positions.

8. The image capturing apparatus providing image blur information according to claim 1, wherein the display displays the information about the degree of image blur in the form of a pie chart or bar chart in percentage.

9. The image capturing apparatus providing image blur information according to claim 1, wherein the apparatus further comprises:
a button unit outputting a triggering signal to the processing unit to generate the shooting signal; and
a register being connected between the image capturing unit and the processing unit to temporarily store the first image and the second image captured by the image capturing unit and then provide them for the processing unit.

10. A method for providing image blur information, being applied to the image capturing apparatus at the shooting mode of which the shooting shutter speed is greater than the safe shutter speed, comprising steps of:
capturing a first image at the shooting shutter speed and a second image at a shutter speed less than the safe shutter speed;
searching multiple characteristic positions corresponding between the first image and the second images;
using the characteristic positions correspondingly between the first image and the second image to perform a comparison, in order to use the second image as a relative reference to the first image's characteristic positions so a compared result can be generated; and
using the comparison result to operate and define the degree of image blur;
then, the image capturing apparatus providing the degree of image blur information about the first image.

11. The method for providing image blur information according to claim 10, wherein the characteristic position used for characteristic comparison may be an Edge, a Corner, or a Line.

12. The method for providing image blur information according to claim 10, wherein each of the characteristic positions is provided with a weight (importance value), and the weights of each kinds of the characteristic positions are to be set in proportion to the same weights or to dissimilar weights according to the coordinate difference of characteristic positions.

13. The method for providing image blur information according to claim 12, wherein at the step of comparison, a characteristic coincidence value is generated at each of the characteristic positions of the first image, and at the step of operation, the characteristic coincidence value is multiplied by the weight of each of the characteristic weights for a total sum to define the degree of image blur.

14. The method for providing image blur information according to claim 12, wherein at the step of comparison, a characteristic blur degree is generated at each of the characteristic positions of the first image, and at the step of operation, the characteristic blur degree is multiplied by the weight of each of the characteristic weights for a total sum to define the degree of image blur.

15. The method for providing image blur information according to claim 10, wherein the method further comprises providing a display in the image capturing apparatus to show the first image and receiving the degree of image blur to show the information about the degree of image blur when the first image is shown.

16. The method for providing image blur information according to claim 15, wherein the display displays the information about the degree of image blur in the form of a pie chart or bar chart in percentage.
